(19) United States
(12) Patent Application Publication
(10) Pub. No.: US 2016/0295617 A1
(43) Pub. Date: Oct. 6, 2016

(54) MOBILE COMMUNICATION METHOD

(71) Applicant: NTT DOCOMO, INC., Chiyoda-ku, Tokyo (JP)

(72) Inventors: Wuri Andarmawanti Hapsari, Tokyo (JP); Hideaki Takahashi, Tokyo (JP); Tooru Uchino, Tokyo (JP)

(73) Assignee: NTT DOCOMO, INC., Tokyo (JP)

(21) Appl. No.: 15/033,149

(22) PCT Filed: Oct. 30, 2014
(86) PCT No.: PCT/JP2014/078886

§ 371 Date: Apr. 29, 2016

(30) Foreign Application Priority Data
Oct. 31, 2013 (JP) 2013-227526

(51) Int. Cl. H04W 76/02; H04W 72/04

(52) U.S. Cl. CPC H04W 76/02; H04W 72/04

(57) ABSTRACT

An object is to realize “2DL, 1UL” “Inter-eNB CA”. A mobile communication method according to the present invention includes, a radio base station (MeNB) transmitting, when a bearer #1 has been set between a mobile station (UE) and the radio base station (MeNB), to the mobile station (UE) an information element “DRB-ToAddMod_SeNB” or “DRB-ToAddMod” that instructs to add a bearer #2 between a radio base station (SeNB) and to modify the settings of the bearer #1; and the mobile station (UE) modifying, according to the information element “DRB-ToAddMod_SeNB” or “DRB-ToAddMod”, the settings of the bearer #1, and adding the bearer #2 to receive a downlink signal via the bearer #1 and the bearer #2 and transmit an uplink signal via either the bearer #1 or the bearer #2.

### TECHNICAL FIELD

The present invention relates to a mobile communication method.

### BACKGROUND ART

Presently, in 3GPP, architectures to realize “Inter-eNB CA (Carrier Aggregation)” as WI (Working Item) of SCE (Small Cell Enhancement) are being discussed.

Specifically, a detailed study regarding two architectures, i.e. , “Option 1” shown in FIG. 9(a) and “Option 2” shown in FIG. 9(b), will be undertaken.

In the “Option 1” architecture, as shown in FIG. 9(a), a serving gateway device S-GW routes a downlink signal that is addressed to a mobile station UE to a radio base station MeNB (Master eNB) or a radio base station SeNB (Secondary eNB).

In the “Option 1” architecture, each of the radio base station MeNB and the radio base station SeNB includes PDCP (Packet Data Convergence Protocol) layer function, and “Bearer split” in which one EPS bearer is set via two radio base stations eNB cannot be implemented.

On the other hand, in the “Option 2” architecture, as shown in FIG. 9(b), the radio base station MeNB routes a downlink signal that is addressed to the mobile station UE to the radio base station SeNB.

In the “Option 2” architecture, only the radio base station MeNB includes the PDCP layer function, and the “Bearer split” can be implemented.

### PRIOR ART DOCUMENT

### Non-Patent Document

Non-Patent Document 1: 3GPP TR36.842, “Study on Small Cell Enhancements for E-UTRA and E-UTRAN - Higher layer aspects”

### SUMMARY OF THE INVENTION

The SCE aims at enhancing throughput of a mobile station UE while maintaining the quality of Mobility of the mobile station UE.

From the point of view of the throughput enhancement, enhancement of throughput in downlink, in particular, is in focus.

When realizing the “Inter-eNB CA” by using the “Option 2” architecture, the “Inter-eNB CA” can be performed in both of the downlinks and both of the uplinks, in other words, “2DL, 2UL” “Inter-eNB CA” can be performed.

However, in realizing the “Inter-eNB CA” in both of the uplinks, in other words, in realizing “2UL” “Inter-eNB CA”, there was a problem that the impact on the mobile station UE was significant.

To reduce the complexity of the processing performed in the mobile station UE, an approach of realizing “2DL, 1UL” “Inter-eNB CA” in which an uplink signal is transmitted by using either the radio base station MeNB or the radio base station SeNB, along with realizing the “Inter-eNB CA” in downlink by the “Bearer split”, is being considered.

However, in the existing LTE (Long Term Evolution) system, as shown in FIG. 10, an information element “DRB-ToAddMod”, which is used to add a bearer or modify setting contents of the bearer, is configured to instruct to add a bearer or modify the setting contents of the bearer without being aware of downlink and uplink.

Therefore, in the information element “DRB-ToAddMod”, there was a problem that the “2DL, 1UL” “Inter-eNB CA” explained above could not be realized.

The present invention has been made in view of the above circumstances. It is an object of the present invention to provide a mobile communication method that is capable of realizing the “2DL, 1UL” “Inter-eNB CA”.

According to a first aspect of the present embodiment, a mobile communication method includes, when a first bearer has been set between a mobile station and a first radio base station, the first radio base station transmitting to the mobile station an information element that instructs to add a second bearer between a second radio base station and to modify settings of the first bearer, and the mobile station, according to the information element, modifying the settings of the first bearer and adding the second bearer to receive a downlink signal via the first bearer and the second bearer and transmit an uplink signal via either the first bearer or the second bearer.

### BRIEF DESCRIPTION OF DRAWINGS

FIG. 1 is an overall structural diagram of a mobile communication system according to an embodiment of the present invention.

FIG. 2 is a sequence diagram for explaining a downlink bearer in the mobile communication system according to the embodiment of the present invention.

FIG. 3 is a sequence diagram for explaining an uplink bearer in the mobile communication system according to the embodiment of the present invention.

FIG. 4 is a sequence diagram for explaining an uplink bearer in the mobile communication system according to the embodiment of the present invention.

FIG. 5 is a sequence diagram for explaining an operation of the mobile communication system according to the embodiment of the present invention.

FIG. 6 is a diagram that shows an example of a format of an information element “DRB-ToAddMod_SeNB” that is used in the mobile communication system according to the embodiment of the present invention.

FIG. 7 is a diagram that shows an example of a format of an information element “DRB-ToAddMod” that is used in the mobile communication system according to the embodiment of the present invention.

FIG. 8 is a diagram that shows an example of a format of the information element “DRB-ToAddMod” that is used in the mobile communication system according to the embodiment of the present invention.

FIG. 9 is a view for explaining an architecture to realize the conventional “Inter-eNB CA (Carrier Aggregation)”.

FIG. 10 is a view for explaining an example of a format of a conventional information element “DRB-ToAddMod”.

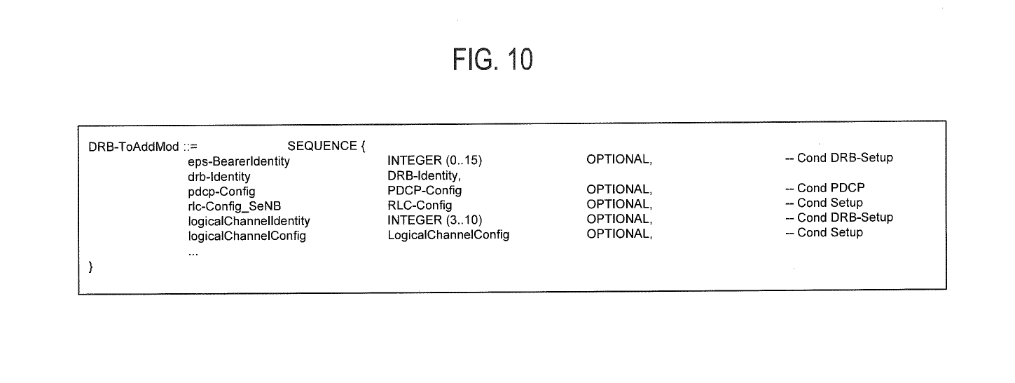

### DETAILED DESCRIPTION

### Mobile Communication System According to Embodiment of Present Invention

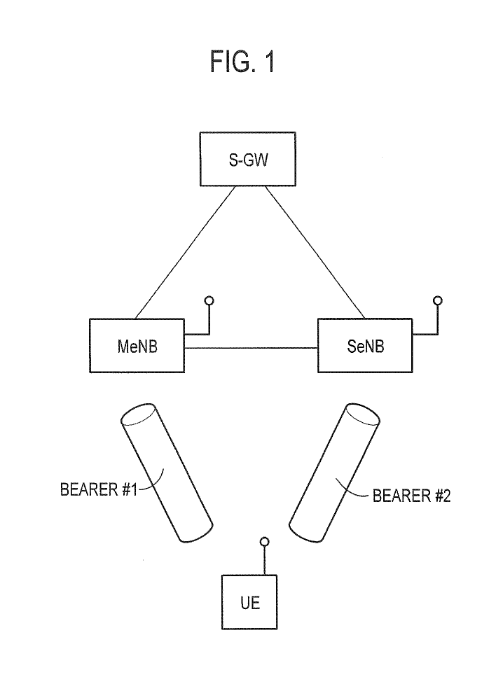

Referring to FIGS. 1 to 8, a mobile communication system according to an embodiment of the present invention is explained below.

The mobile communication system according to the present embodiment is a mobile communication system of the LTE system (or, LTE-Advanced system). The mobile communication system includes, as shown in FIG. 1, a serving gateway device S-GW, a radio base station MeNB, and a radio base station SeNB.

In the mobile communication system according to the present embodiment, as shown in FIG. 1, a bearer #1 is set between the radio base station MeNB and a mobile station UE, and a bearer #2 is set between the radio base station SeNB and the mobile station UE.

In the mobile communication system according to the present embodiment, the “2DL, 1UL” “Inter-eNB CA” is realized.

In other words, in the mobile communication system according to the present embodiment, the “2DL, 1UL” “Inter-eNB CA” in which an uplink signal is transmitted by using either the radio base station MeNB or the radio base station SeNB is realized, along with realizing the “Inter-eNB CA” in downlink by the “Bearer split”.

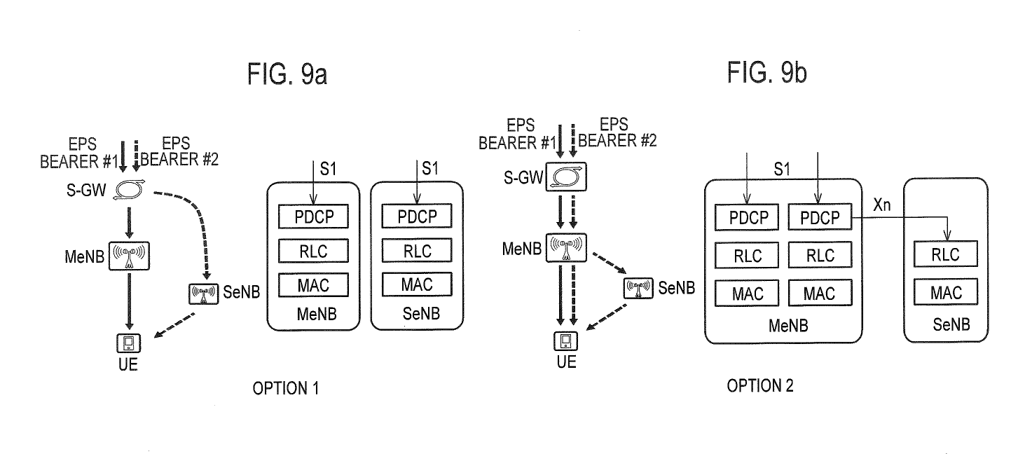

Specifically, in the downlink, the “Option 2” architecture shown in FIG. 9(b) is used, and the radio base station MeNB transmits to the mobile station UE the downlink signal that is addressed to the mobile station UE via the bearer #1, and routes the downlink signal that is addressed to the mobile station UE to the radio base station SeNB.

On the other hand, in the uplink, the “Option 1” architecture shown in FIG. 9(a) is used, and the mobile station UE transmits the uplink signal via either the bearer #1 or the bearer #2.

In the mobile communication system according to the present embodiment, which bearer between the bearer #1 and the bearer #2 shall be used by the mobile station UE to transmit the uplink signal is set by “RRC Connection Reconfiguration”, and it is possible to configure so that this setting cannot be dynamically modified for each subframe.

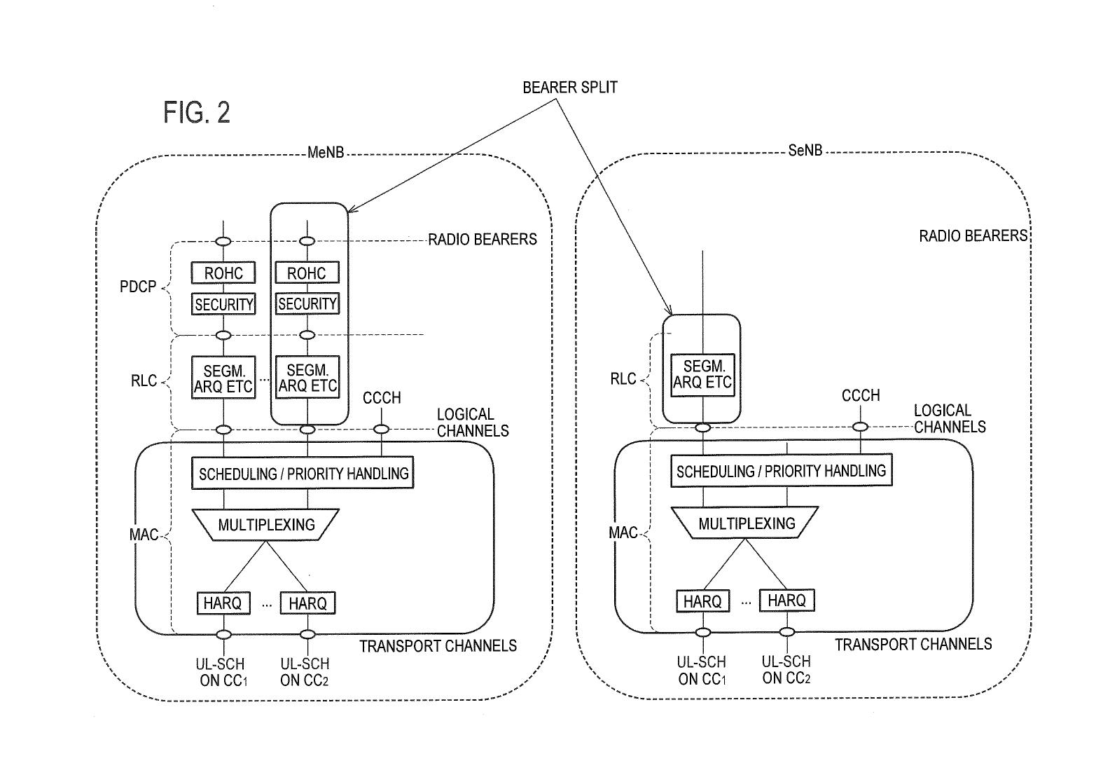

FIG. 2 shows a configuration for downlink when the “2DL, 1UL” “Inter-eNB CA” is being performed.

As shown in FIG. 2, the radio base station MeNB includes, as the configuration for downlink, PDCP layer function, RLC (Radio Link Control) layer function, and MAC (Media Access Control) layer function.

On the other hand, as shown in FIG. 2, the radio base station SeNB includes, as the configuration for downlink, the RLC layer function and the MAC layer function, but does not include the PDCP layer function.

The PDCP layer function of the radio base station MeNB sets “Security context” of the mobile station UE, and performs a security process in a bearer for downlink.

The PDCP layer function of the mobile station UE sets, to perform the security process in the bearer for downlink, the “Security context” set by the PDCP layer function of the radio base station MeNB.

Moreover, the PDCP layer function of the radio base station MeNB performs RoHC (Robust Header Compression) process in the bearer for downlink.

Alternatively, as shown in FIG. 2, when “MAC-ID” is not set in the downlink signal transmitted from the radio base station MeNB (or, when “MAC-ID=0” is set) , “MAC-ID=1” can be set in the downlink signal transmitted from the radio base station SeNB.

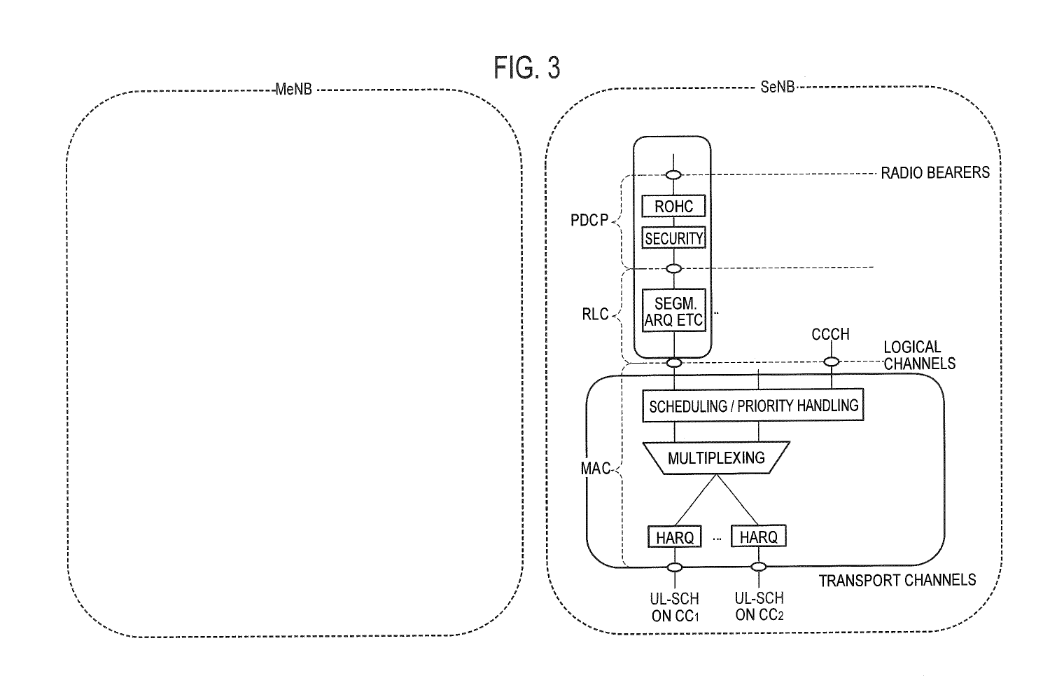

FIG. 3 shows a configuration for uplink when the “2DL, 1UL” “Inter-eNB CA” is being performed. FIG. 3 shows a configuration for uplink for a situation where the mobile station UE transmits the uplink signal via the bearer #2.

As shown in FIG. 3, the radio base station SeNB includes, as the configuration for uplink, the PDCP layer function, the RLC layer function, and the MAC layer function.

On the other hand, as shown in FIG. 3, the radio base station MeNB does not include the configuration for uplink.

The PDCP layer function of the radio base station SeNB sets the “Security context” of the mobile station UE, and performs a security process in a bearer for uplink.

The PDCP layer function of the mobile station UE sets, to perform the security process in the bearer for uplink, the “Security context” set by the PDCP layer function of the radio base station SeNB.

Moreover, the PDCP layer function of the radio base station SeNB performs the RoHC process in the bearer for uplink.

Alternatively, as shown in FIG. 3, the mobile station UE can set, according to the settings performed by the “RRC Connection Reconfiguration”, the “MAC-ID=1” in the uplink signal to be transmitted to the radio base station SeNB.

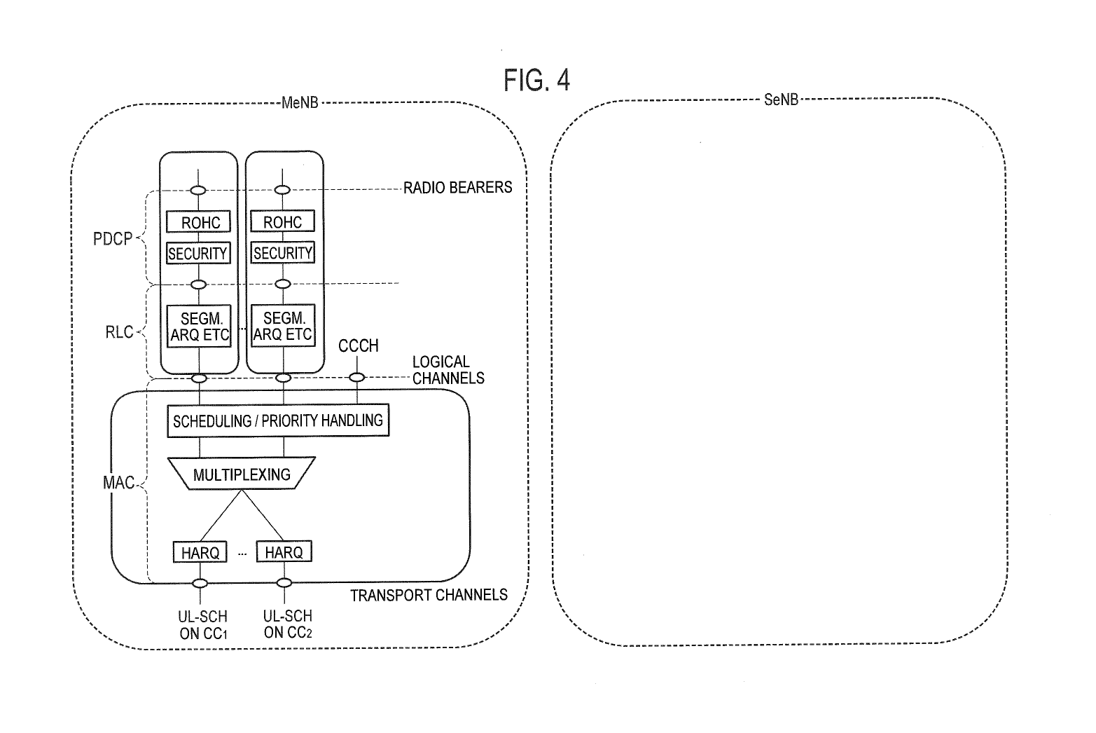

FIG. 4 shows a configuration for uplink when the “2DL, 1UL” “Inter-eNB CA” is being performed. FIG. 4 shows a configuration for uplink for a situation where the mobile station UE transmits the uplink signal via the bearer #1.

As shown in FIG. 4, the radio base station MeNB includes, as the configuration for uplink, the PDCP layer function, the RLC layer function, and the MAC layer function.

On the other hand, as shown in FIG. 4, the radio base station SeNB does not include the configuration for uplink.

The PDCP layer function of the radio base station MeNB sets the “Security context” of the mobile station UE, and performs a security process in the bearer for uplink.

The PDCP layer function of the mobile station UE sets, to perform the security process in the bearer for uplink, the “Security context” set by the PDCP layer function of the radio base station MeNB.

Moreover, the PDCP layer function of the radio base station MeNB performs the RoHC process in the bearer for uplink.

Alternatively, as shown in FIG. 4, the mobile station UE can set, according to the settings performed by the “RRC Connection Reconfiguration”, the “MAC-ID=0” in the uplink signal to be transmitted to the radio base station MeNB.

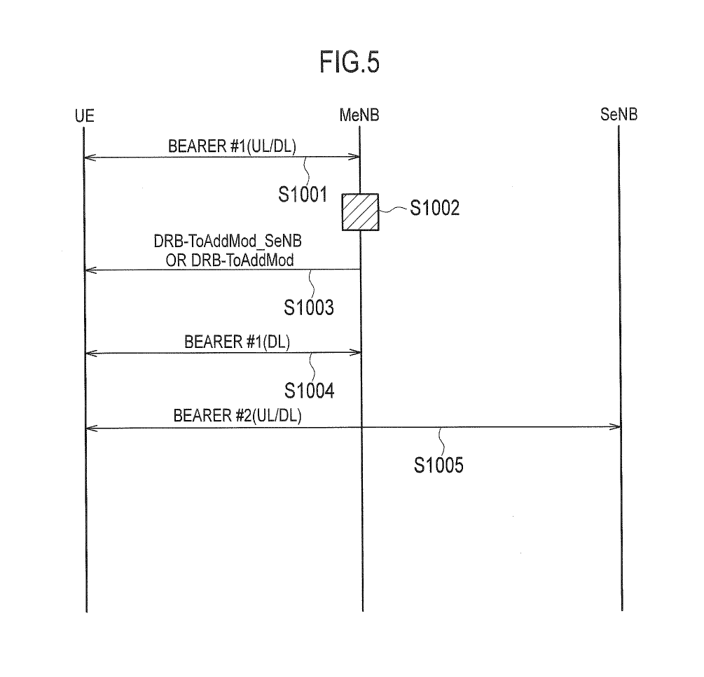

Referring to FIG. 5, an example of a concrete operation of the mobile communication system according to the present embodiment is explained below.

As shown in FIG. 5, at Step S1001, the bearer #1 is set between the mobile station UE and the radio base station MeNB, and in this state, at Step S1002, the radio base station MeNB determines to perform the “2DL, 1UL” “Inter-eNB CA” with the radio base station SeNB. Next, at Step S1003, the radio base station MeNB transmits to the mobile station UE the “RRC Connection Reconfiguration” that includes an information element “DRB-ToAddMod SeNB” or “DRB-ToAddMod”.

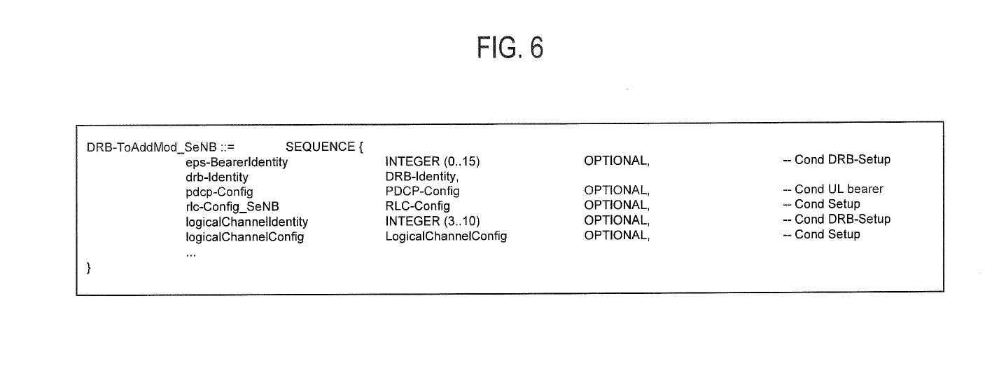

An example of a format of the information element “DRB-ToAddMod_SeNB” or “DRB-ToAddMod” is shown in FIGS. 6 to 8.

The mobile station UE, according to the information element “DRB-ToAddMod_SeNB” or “DRB-ToAddMod”, modifies the settings of the bearer #1 at Step S1004, and adds the bearer #2 at Step S1005, so that the downlink signal is received via the bearer #1 and the bearer #2 and the uplink signal is transmitted via either the bearer #1 or the bearer #2, in other words, to transmit the uplink signal via either the bearer #1 or the bearer #2.

The mobile station UE, upon receiving the information element “DRB-ToAddMod_SeNB” shown in FIG. 6, can modify the setting contents of the bearer #1 so that the bearer #1 acts as the bearer for downlink and can add the bearer #2 as a bearer for downlink and uplink.

Alternatively, the mobile station UE, upon receiving the information element “DRB-ToAddMod_SeNB” shown in FIG. 6, can retain the setting contents of the bearer #1 and can add the bearer #2 as the bearer for downlink.

For example, when “PDCP-config” has been set in the information element “DRB-ToAddMod_SeNB”, the mobile station UE can modify the settings of the bearer #1 and can add the bearer #2 to transmit the uplink signal via the bearer #2.

Specifically, in this situation, the mobile station UE can associate the “PDCP-config”, which includes the setting contents related to the bearer for uplink, with the radio base station SeNB (SeNB-ID)

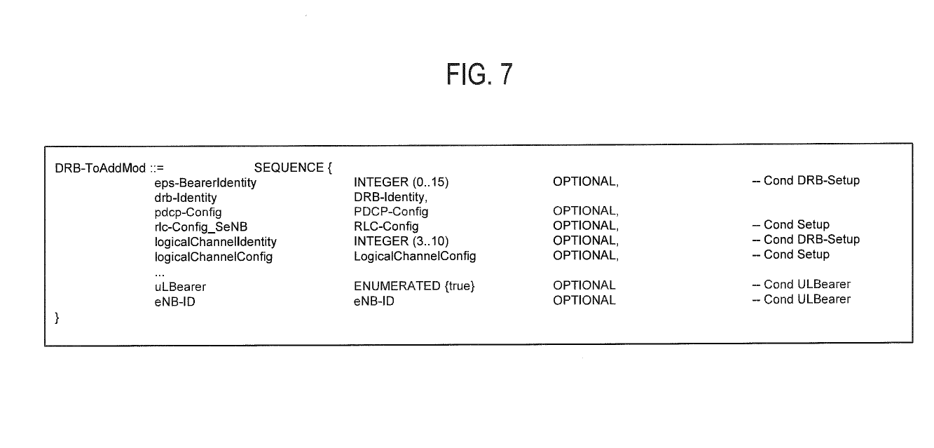

Moreover, the mobile station UE, upon receiving the information element “DRB-ToAddMod” shown in FIG. 7, can modify the setting contents of the bearer #1 so that the bearer #1 acts as the bearer for downlink and can add the bearer #2 as the bearer for downlink and uplink.

For example, when the “PDCP-config” has been set in the information element “DRB-ToAddMod” (and, when MAC-ID=1 is set), the mobile station UE can modify the settings of the bearer #1 and can add the bearer #2 to transmit the uplink signal via the bearer #2.

Specifically, in this situation, the mobile station UE can associate the “PDCP-config”, which includes the setting contents related to the bearer for uplink, with the radio base station SeNB (SeNB-ID).

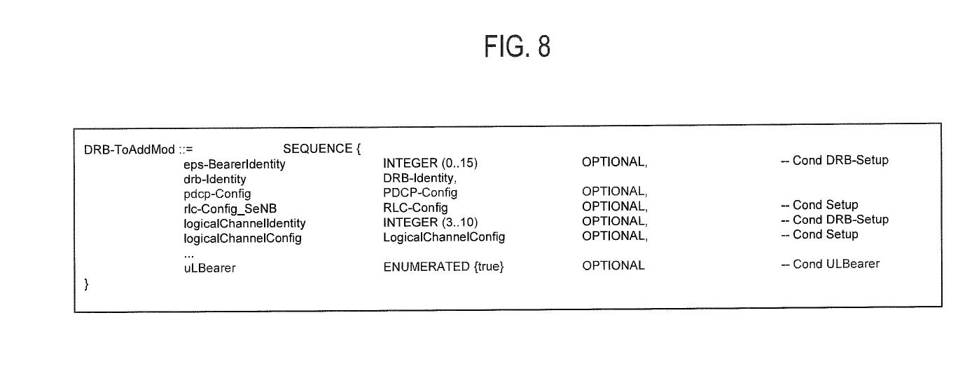

Furthermore, the mobile station UE, upon receiving the information element “DRB-ToAddMod” shown in FIG. 8, can retain the setting contents of the bearer #1 and can add the bearer #2 as the bearer for downlink.

For example, when the “PDCP-config” has been set in the information element “DRB-ToAddMod” (and, when MAC-ID is not set) , the mobile station UE can modify the settings of the bearer #1 and can add the bearer #2 to transmit the uplink signal via the bearer #1.

Specifically, in this situation, the mobile station UE can associate the “PDCP-config”, which includes the setting contents related to the bearer for uplink, with the radio base station MeNB (MeNB-ID).

The characteristics of the present embodiment explained above can be expressed as follows.

According to a first aspect of the present embodiment, a mobile communication method includes a step in which a radio base station MeNB (a first radio base station) transmits, when a bearer #1 (a first bearer) has been set between a mobile station UE and the radio base station MeNB, to the mobile station UE an information element “DRB-ToAddMod_SeNB” or “DRB-ToAddMod” that instructs to add a bearer #2 (a second bearer) between a radio base station SeNB (a second radio base station) and to modify settings of the bearer #1; and a step in which the mobile station UE, according to the information element “DRB-ToAddMod_SeNB” or “DRB-ToAddMod”, modifies the settings of the bearer #1 and adds the bearer #2 to receive a downlink signal via the bearer #1 and the bearer #2 and transmit an uplink signal via either the bearer #1 or the bearer #2.

According to the above aspect, the “2DL, 1UL” “Inter-eNB CA” can be realized while reducing the complexity of the processing performed in the mobile station UE.

In the first aspect of the present embodiment, a step A can include the radio base station MeNB transmitting the information element “DRB-ToAddMod_SeNB” or “DRB-ToAddMod” to the mobile station UE by the “RRC Connection Reconfiguration”.

In the first aspect of the present .embodiment, a step B can include, when “PDCP-config” has been set in the information element “DRB-ToAddMod”, the mobile station UE modifying the settings of the bearer #1 and adding the bearer #2 to transmit the uplink signal via the bearer #1.

In the first aspect of the present embodiment, the step B includes, when the “PDCP-config” has been set in the information element “DRB-ToAddMod_SeNB”, the mobile station UE modifying the settings of the bearer #1 and adding the bearer #2 to transmit the uplink signal via the bearer #2.

According to a second aspect of the present embodiment, in a mobile communication system in which a mobile station UE is capable of performing the “Inter-eNB CA (carrier aggregation)” by using a radio base station MeNB and a radio base station SeNB, when the “Inter-eNB CA” is being performed, PDCP layer function corresponding to a bearer for downlink is set only in the radio base station MeNB, and PDCP layer function corresponding to a bearer for uplink is set in either the radio base station MeNB or the radio base station SeNB.

In the second aspect of the present embodiment, the PDCP function layer can perform a security process.

In the second aspect of the present embodiment, the PDCP function layer can perform RoHC process.

In the second aspect of the present embodiment, the mobile station UE can associate “PDCP-config (setting contents related to bearers)” with either the radio base station MeNB or the radio base station SeNB.

Operations of the above mobile station UE, the radio base station MeNB/SeNB, and the serving gateway device S-GW can be realized by hardware, can be realized by a software module executed by a processor, or can be realized by the combination of these.

The software module can be arranged in a storage medium having a desired form such as RAM (Random Access Memory), a flash memory, ROM (Read Only Memory), EPROM (Erasable Programmable ROM), EEPROM (Electronically Erasable and Programmable ROM), a register, a hard disk, a removable disk, CD-ROM, and the like.

The storage medium is connected to a processor so that the processor can read/write information from/in the storage medium. Alternatively, the storage medium can be integrated in a processor. Alternatively, the storage medium and the processor can be arranged in ASIC. The ASIC can be arranged in the mobile station UE, the radio base station MeNB/SeNB, and the serving gateway device S-GW. The storage medium and the processor can be arranged as a discrete component in the mobile station UE, the radio base station MeNB/SeNB, and the serving gateway device S-GW.

The present invention has been explained in detail by using the above mentioned embodiments; however, it is obvious for a person skilled in the art that the present invention is not limited to the embodiments explained in the present description. The present invention can be implemented by way of modifications and changes without deviating from the gist and the range of the present invention specified by the claims. Accordingly, the indication of the present description aims at exemplary explanation, and has no intention to limit to the present invention.

The entire contents of Japanese Patent Application 2013-227526 (filed on Oct. 31, 2013) are incorporated in the description of the present application by reference.

### INDUSTRIAL APPLICABILITY

According to the present invention, as explained above, it is possible to provide a mobile communication method that is capable of realizing the “2DL, 1UL” “Inter-eNB CA”.

### EXPLANATION OF REFERENCE NUMERALS

UE Mobile station
MeNB, SeNB Radio base station
S-GW Serving gateway device

1. A mobile communication method comprising:
a step A in which a first radio base station transmits, when a first bearer has been set between a mobile station and the first radio base station, to the mobile station an information element that instructs to add a second bearer between a second radio base station and to modify settings of the first bearer; and
a step B in which the mobile station, according to the information element, modifies the settings of the first bearer and adds the second bearer to receive a downlink signal via the first bearer and the second bearer and transmit an uplink signal via either the first bearer or the second bearer.

2. The mobile communication method as claimed in claim 1, wherein the step A includes the first radio base station transmitting the information element to the mobile station by “RRC Connection Reconfiguration”.

3. The mobile communication method as claimed in claim 1, wherein
the step B includes, upon receiving an existing information element “DRB-ToAddMod” as the information element and when “PDCP-config” has been set in the information element “DRB-ToAddMod”, the mobile station modifying the settings of the first bearer and adding the second bearer to transmit the uplink signal via the second bearer.

4. The mobile communication method as claimed in claim 1, wherein
the step B includes, upon receiving an information element for the second radio base station “DRB-ToAddMod_SeNB” as the information element and when the “PDCP-config” has been set in the information element “DRB-ToAddMod_SeNB”, the mobile station modifying the settings of the first bearer and adding the second bearer to transmit the uplink signal via the second bearer.

5. A mobile communication system in which a mobile station is capable of performing a carrier aggregation by using a first radio base station and a second radio base station, wherein
when the carrier aggregation is being performed, PDCP layer function corresponding to a bearer for downlink is set in only the first radio base station, and PDCP layer function corresponding to a bearer for uplink is set in either the first radio base station or the second radio base station.

6. The mobile communication system as claimed in claim 5, wherein the PDCP layer function performs a security process.

7. The mobile communication system as claimed in claim 5, wherein the PDCP layer function performs RoHC process.

8. The mobile communication system as claimed in claim 5, wherein the mobile station associates setting contents related to the bearer for uplink with either the first radio base station or the second radio base station.

9. The mobile communication method as claimed in claim 2, wherein
the step B includes, upon receiving an existing information element “DRB-ToAddMod” as the information element and when “PDCP-config” has been set in the information element “DRB-ToAddMod”, the mobile station modifying the settings of the first bearer and adding the second bearer to transmit the uplink signal via the second bearer.

10. The mobile communication method as claimed in claim 2, wherein
the step B includes, upon receiving an information element for the second radio base station “DRB-ToAddMod SeNB” as the information element and when the “PDCP-config” has been set in the information element “DRB-ToAddMod_SeNB”, the mobile station modifying the settings of the first bearer and adding the second bearer to transmit the uplink signal via the second bearer.

11. The mobile communication system as claimed in claim 6, wherein the PDCP layer function performs RoHC process.
